(19) United States
(12) Patent Application Publication
(10) Pub. No.: US 2017/0211540 A1
(43) Pub. Date: Jul. 27, 2017

(54) HYDRAULIC POWER GENERATION DEVICE

(71) Applicant: SHUI-CHUAN CHEN, TAINAN CITY (TW)

(72) Inventor: SHUI-CHUAN CHEN, TAINAN CITY (TW)

(21) Appl. No.: 15/481,970

(22) Filed: Apr. 7, 2017

Related U.S. Application Data
(63) Continuation-in-part of application No. 14/952,057, filed on Nov. 25, 2015.
Application No. 14/952,057 is a continuation-in-part of application No. 14/300,320, filed on Jun. 10, 2014, now abandoned.

(51) Int. Cl. F03B 13/06; H02K 7/18; F03B 17/00

(52) U.S. Cl. CPC F03B 13/06; F03B 17/005; H02K 7/1823; F03B 17/04

(57) ABSTRACT

A hydraulic power generation device includes a water passage unit arranged slantingly with multiple water turbines located above the water passage unit. The water passage unit is disposed in a space of a case. Multiple containers are located beneath the water passage unit and located corresponding to the water turbines respectively. The water passage unit has an inlet and an outlet located corresponding to each of the containers. The inlet and the outlet communicate with the room of the container corresponding thereto. When one of the water turbines or an electric power generator needs to be maintained, a seal of the inlet is opened and the water flows to the water passage unit via the outlet to drive the water turbines behind the damaged water turbine. The hydraulic power generation device is still under operation while one of the water turbines is under maintenance.

### CROSS REFERENCE TO RELATED APPLICATION

This application is a continuation-in-part of application Ser. No. 14/952,057, filed on Nov. 25, 2015, currently pending, which is a continuation-in-part of application Ser. No. 14/300,320, filed on Jun. 10, 2014, now abandoned, the subject matter of which is incorporated herein by reference.

### BACKGROUND OF THE INVENTION

1. Fields of the invention

The present invention relates to a hydraulic power generation device, and more particularly, to a hydraulic power generation device which comprises multiple water passage units which are able to be maintained individually.

2. Descriptions of Related Art

The conventional hydraulic power generation device is built in those areas with plenty of water. Please refer to European Patent Pub. No. EP2434139A1 titled “Circulating electric generator” and U.S. Pat. No. 5,420,463 titled “Fluid driven power system”, they primarily comprise water passages in a system, and multiple water turbines are located above the water passages so as to be driven by the water to generate mechanical energy. An electric power generation unit is connected to and driven by each of the water turbines to transform the mechanical energy into electric energy. The electric energy can be stored in batteries for driving other equipment and a pump of the system so that water on a bottom of a water storage tank can be pumped by the pump to an upper portion of the water storage tank to use the water in the water storage tank repeatedly to form a circulating system. However, for the conventional hydraulic power generation device, when one of the mills or the electric power generation unit needs to be maintained, in order to keep the water away from the water turbine or the electric power generation unit to avoid dangerous result, the operation of the whole hydraulic power generation device has to be stopped until the maintenance is finished. The conventional way of maintenance reduces the efficiency of the hydraulic power generation device. Frequent switching on and off will also shorten the life of use of the hydraulic power generation device.

The present invention intends to provide a hydraulic power generation device which eliminates the shortcomings mentioned above.

### SUMMARY OF THE INVENTION

The primary object of the present invention is to provide a hydraulic power generation device which does not need to stop the operation of the hydraulic power generation device while one of the water turbines or the electric power generator needs to be repaired.

In order to achieve the above object, a hydraulic power device having a divertible flow according to the present invention includes a water passage, a plurality of water turbines, a plurality of containers, a case, a pump, and an external water supply. The water passage unit includes a high end and a low end. The water turbines are arranged above the water passage unit and a bottom of each water turbine is disposed within the water passage unit. The containers are disposed beneath the water passage unit and each container is corresponding to the respective water turbine. Each container includes a room defined therein. The water passage unit has a plurality of inlets and outlets. Each inlet and each outlet are corresponding to the respective container and communicating with the room of the container. Each of the inlets and the outlets has a seal connected thereto and each turbine is disposed between the inlet and the outlet of the container correspondingly thereto. The case includes a space defined therein. The water passage unit is disposed in the space and each of the water turbines is connected to an electric power generator that is located outside of the case. An electric power storage unit is set outside of the case and connected to the electric power generator of each of the water turbine. The pump is arranged at a bottom of the space of the case and is connected to a first end of a pipe while a second end of the pipe is extended to an opening above the space of the case. The pump is further connected to the electric power storage unit and to an external power supply unit for providing an initial power used to initiate the pump. The external water supply is connected to one side of the case and located between a top of the pump and the lowest water passage for allowing water being injected therefrom to the space of the case. The injection of the water is stopped when a level of the water in the space is higher than water level of the pump.

The water passage unit includes at least a first passage and a second passage which is located below the first passage. A low end of the inclined first passage is corresponding to a high end of the inclined second passage. The first and second passages are inclined toward different directions.

The case includes a plurality of boxes each of which has a space defined therein. The passages of the water passage unit and the water turbines are collectively disposed within the plurality of boxes. Each of the boxes has a first opening and a second opening. The first opening is disposed on the high end of the passage of the water passage unit within the box while the second opening is arranged at the low end of the passage of the water passage unit within the box.

The first passage and the second passage are respectively located in the two adjacent boxes.

A base chamber is disposed in the lowest box of the case; the base chamber has an opening defined in a top thereof; the second end of the pipe connected to the pump is extended to the first opening of the highest box of the case.

The external water supply is disposed on one side of the box adjacent to the lowest box of the case.

Thereby the seal of the inlet is opened and the water flows to the water passage unit via the outlet to drive the water turbines behind the damaged water turbine when one of the water turbines or the electric power generator need to be maintained. The hydraulic power generation device is still under operation while one of the water turbines is under maintenance.

### BRIEF DESCRIPTION OF THE DRAWINGS

FIG. 1 is a cross sectional view of the hydraulic power generation device of the present invention;

FIG. 2 shows the water passage and the water turbines of the hydraulic power generation device of the present invention;

FIG. 3 shows the operation status of the water passage and the water turbines of the hydraulic power generation device of the present invention, and

FIG. 4 is a cross sectional view of another embodiment of the hydraulic power generation device of the present invention.

### DETAILED DESCRIPTION OF THE PREFERRED EMBODIMENT

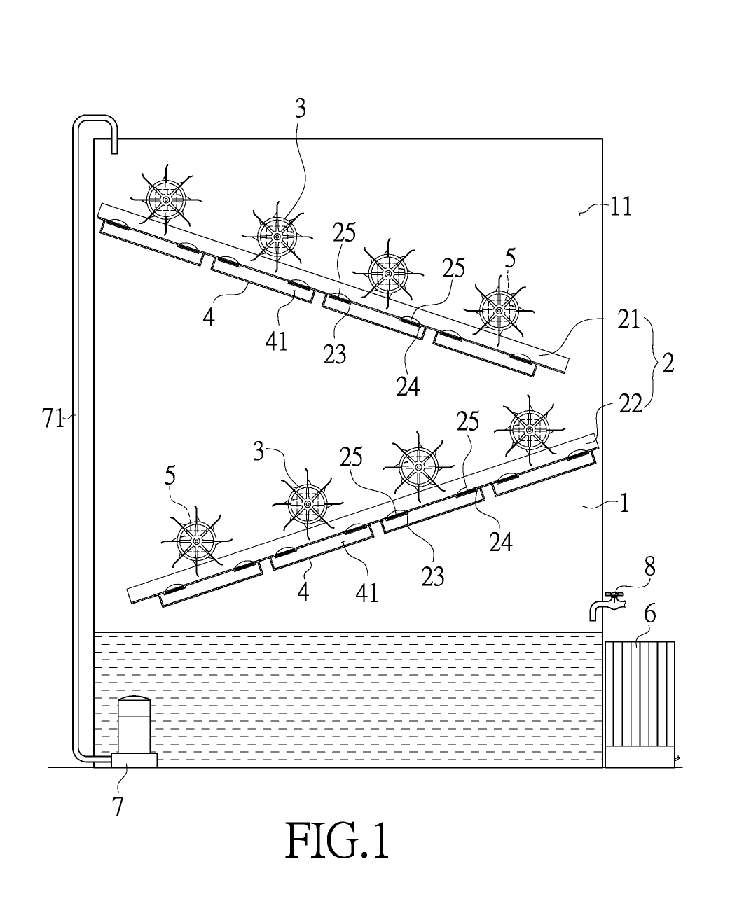

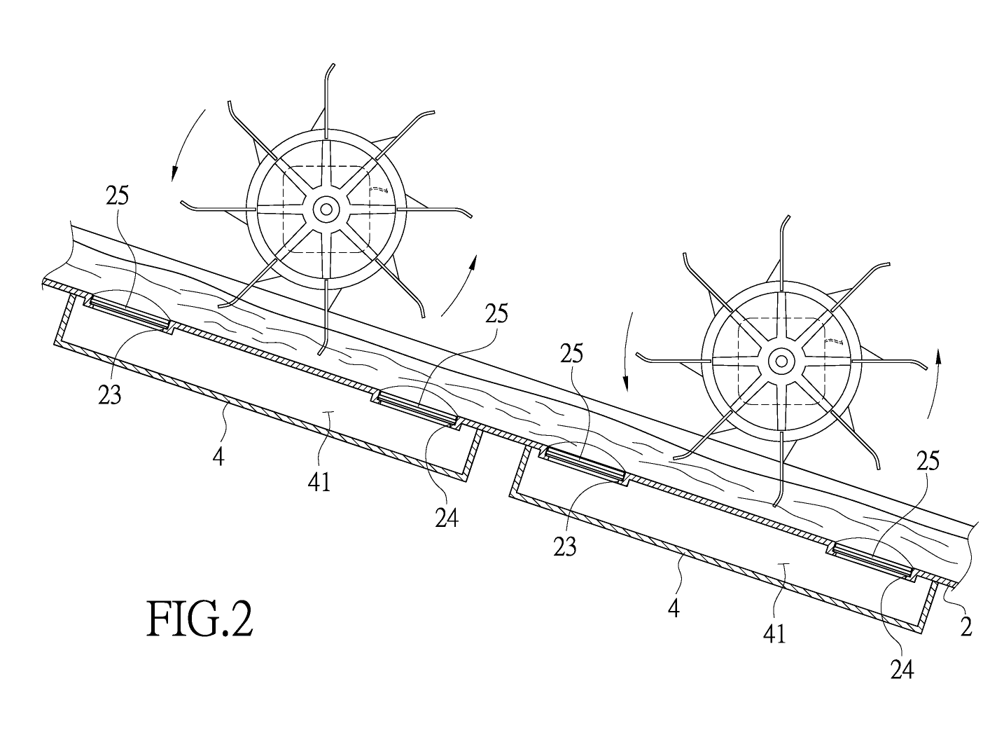

Referring to FIGS. 1 and 2, the hydraulic power generation device of the present invention comprises a case 1 which has a space 11 defined therein and a water passage unit 2 is located in the space 11. In this embodiment, there are at least two water passage units 2, and each water passage unit 2 has a high end and a low end. Taken one of the two water passage units 2 as an example to be described, the water passage unit 2 comprises a first passage 21 and a second water passage 22 which is located below the first passage 21. The first passage 21 is an inclined passage and has a low end and a high end, and the second passage 22 is an inclined passage and has a low end and a high end. The low end of the first passage 21 is located corresponding to the high end of the second passage 22. The first and second passages 21, 22 are inclined toward different directions. Multiple water turbines 3 are located above the water passage unit 2, and the multiple water turbines 3 are inclinedly arranged along the water passage unit 2. A bottom of each water turbine 3 is located within the water passage unit 2. Multiple containers 4 are located beneath the water passage unit 2 and located corresponding to the water turbines 3 respectively. Each container 4 has a room 41 defined therein. The water passage unit 2 has an inlet 23 and an outlet 24 located correspondingly to a high end and a low end of each of the containers 4. Each of the water turbines 3 is located between the inlet 23 and the outlet 24 of the corresponding container 4. The inlet 23 and the outlet 24 communicate with the room 41 of the container 4 correspondingly thereto. The inlet 23 and the outlet 24 are disposed with a seal 25 connected thereto respectively. Each water turbine 3 is connected with an electric power generator 5 which is connected with an electric power storage unit 6. The electric power generator 5 and the electric power storage unit 6 are located outside of the case 1. A pump 7 is located in the bottom of the space 11 of the case 1. The pump 7 is connected to the electric power storage unit 6 and a conductive wire connected to an external power supply unit such as a mains power supply or a power source of a generator. The pump 7 is connected to a first end of a pipe 71 while a second end of the pipe 71 extends to an opening above the space 11 of the case 1 and is corresponding to the high end of the first passage 21 that is arranged slantingly. One side of the case 1 is connected to an external water supply 8 that is located between the top of the pump 7 and the bottommost water passage 22. The external water supply 8 can be a faucet connected to a water pipe.

Accordingly, when the present invention is implemented, the external water supply 8 injects water into the space 11 of the case 1. The space 11 is filled with a certain height of water. When the water level reaches a required level, the injection of water is stopped, and the water level within the space 11 must be higher than that of the pump 7. An initial power is supplied to the pump 7 by the external power supply unit such as a mains power supply or a power source of a generator through a conductive wire for activating the pump 7. Thus the water in the space 11 is pumped to the upper portion of the space 11 via the pipe 71, and the water flows to the high end of the first passage 21. The water then flows downward along the first passage 21 and toward the low end of the first passage 21. The water flows to the high end of the second passage 22 via the low end of the first passage 21, and the water flows downward along the second passage 22 and toward the low end of the second passage 22. The water flows downward along the third passage, the fourth passage (if available) and so on. The water flows back to the initial water level in the case 1. The water is again pumped by the pump 7 to go through the cycle mentioned again.

When the water flows downward, the water turbines 3 are driven and rotated so as to activate the electric power generators 5 that are connected with the water turbines 3 so as to generate electric power which is transported to the electric power storage unit 6. The electric power stored in the electric power storage unit 6 can be supplied for driving the pump 7. It is set that power supplied by the external power supply unit such as a mains power supply or a power source of a generator to the pump 7 is stopped when a preset power capacity is received by the electric power storage unit 6, and then power is supplied by the electric power storage unit 6 to the pump 7 directly. Due to that the present invention is provided with a plurality of water turbines 3, each water turbine 3 will be driven to rotate when water flows through each water turbine 3, and mechanical energy can be converted into electric energy by the electric power generator 5 connected to each water turbine 3. Therefore, the electric energy generated by the plurality of water turbines 3 can not only be supplied for driving the pump 7 but also be supplied to be stored in the electric power storage unit 6 for industrial or livelihood use.

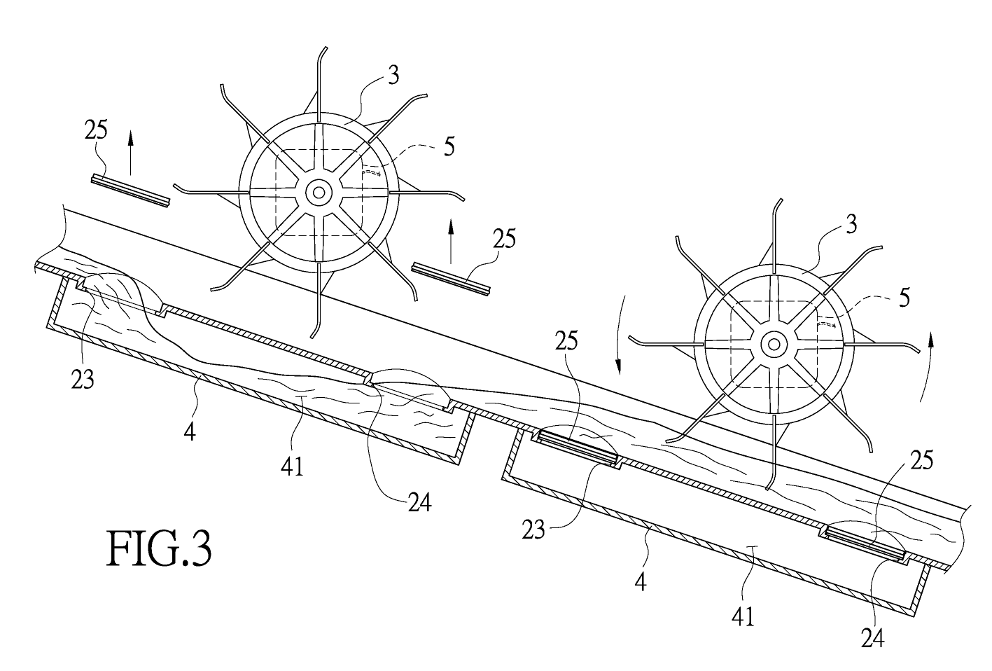

As shown in FIG. 3 when one of the water turbines 3 or the electric power generators 5 needs to be repaired or maintained, the seals 25 of the inlet 23 and the outlet 24 of the container 4 correspondent to the damaged water turbine 3 or the electric power generator 5 are opened. The water enters into the inlet 23 and the room 41 of the container 4, and flows out from the outlet 24 and back to the water passage unit 2 to continuously drive the rest of the water turbines 3. Therefore, the technician can access the damaged water turbine 3 or the electric power generator 5 while the hydraulic power generation device is still in operation. It is noted that the hydraulic power generation device does not need to be shut off while maintaining the damaged water turbine 3 or the electric power generator 5.

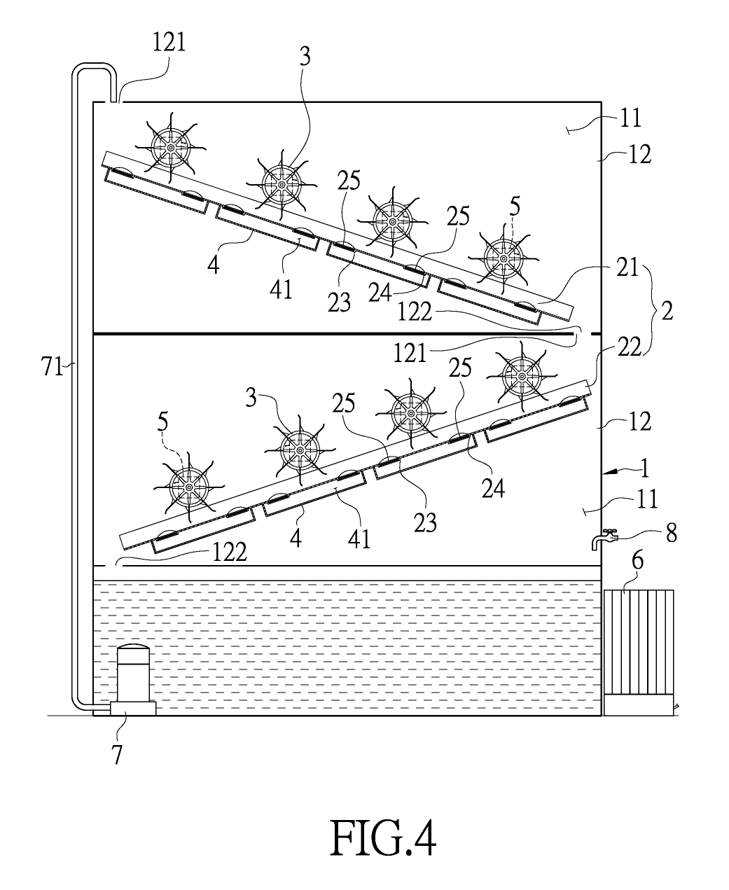

As shown in FIG. 4 which shows another embodiment of the present invention, wherein the case 1 comprises multiple boxes 12 which are overlapped with each other. Each box 12 has a space 11 defined therein. The space 11 of each of the boxes 12 has the water passage unit 2 and the multiple water turbines 3 received therein. A plurality of electric power generators 5 connected to the water turbines 3 respectively are located outside of each of the boxes 12. The first and second passages 21, 22 are inclined toward different directions. Each box 12 has a first opening 121 and a second opening 122, the first opening 121 is located corresponding to the high end of the water passage unit 2, and the second opening 122 is located corresponding to the low end of the water passage unit 2. A pump 7 is located in the bottommost box 12 of the case 1. The lowest (bottommost) box 12 arranged with the pump 7 has an open area in the top thereof. An external water supply 8 is disposed on one side of the box 12 adjacent to the lowest/bottommost box 12.

When in use, injection of the water from the external water supply 8 to the space 11 of the case 1 is stopped when a level of the water is higher than water level of the pump 7. Then the external power supply unit provides the pump 7 an initial power for activating the pump 7. Thus the water in the space 11 is pumped by the pump 7 and delivered to the first opening 121 of the highest box 12 through the pipe 71. Then the water flows downward along the water passage unit 2 and out from the second opening 122. The water then flows into the second box 12 via the first opening 121 of the second box 12. The water flows through the multiple overlapped boxes 12 and drives the water turbines 3 to generate electric power. It is noted that the number of the box 12 can be increased or decreased according to practical needs.

What is claimed is:

1. A hydraulic power device having a divertible flow comprising:
a water passage unit having a high end and a low end;
a plurality of water turbines disposed above the water passage unit, a bottom of each water turbine being disposed within the water passage unit; and,
a plurality of containers disposed beneath the water passage unit and each disposed corresponding to respective ones of the water turbines, each container having a room defined therein, the water passage unit having a plurality of inlets and outlets each disposed corresponding to respective ones of the containers and communicating with the room of the container, each of the inlets and the outlets having a seal connected thereto, each of the water turbines disposed between the inlet and the outlet of the container corresponding thereto,
a case having a space defined therein, the water passage unit disposed in the space; each of the water turbines being connected to an electric power generator that is located outside of the case; an electric power storage unit disposed outside of the case and connected to the electric power generator of each of the water turbine;
a pump disposed on a bottom of the space of the case; the pump connected to a first end of a pipe, a second end of the pipe extending to an opening above the space of the case, the pump connected to the electric power storage unit and to an external power supply unit for providing an initial power used to initiate the pump; and
an external water supply connected to one side of the case and located between a top of the pump and the water passage unit for allowing water being injected therefrom to the space of the case; injection of the water being stopped when a level of the water is higher than water level of the pump.

2. The device as claimed in claim 1, wherein the water passage unit includes at least a first passage and a second passage which is located below the first passage; the first passage is an inclined passage and having a low end and a high end; the second passage is an inclined passage and having a low end and a high end; the low end of the first passage is disposed corresponding to the high end of the second passage; the first and second passages are inclined toward different directions.

3. The device as claimed in claim 2, wherein the case includes a plurality of boxes, each box having a space defined therein; the passages of the water passage unit and the multiple water turbines are collectively disposed within the plurality of boxes; each of the boxes has a first opening and a second opening; the first opening is disposed on the high end of the passage of the water passage unit within the box; the second opening is disposed on the low end of the passage of the water passage unit within the box.

4. The device as claimed in claim 2, wherein the first passage and the second passage are respectively located in the two adjacent boxes.

5. The device as claimed in claim 3, wherein a base chamber is disposed in the lowest box of the case; the base chamber having an opening defined in a top thereof; the second end of the pipe connected to the pump is extended to the first opening of the highest box of the case.

6. The device as claimed in claim 5, wherein the external water supply is disposed on one side of the box adjacent to the lowest box of the case.

7. The device as claimed in claim 1, wherein the case includes a plurality of boxes each of which having a space defined therein; a plurality of passages of the water passage unit and the water turbines are collectively disposed within the plurality of boxes respectively; each of the boxes has a first opening and a second opening the first opening is disposed correspondingly to the high end of the passage of the water passage unit disposed within the box; the second opening is disposed correspondingly to the low end of the passage of the water passage unit disposed within the box.

8. The device as claimed in claim 7, wherein a base chamber is disposed in the lowest box of the boxes of the case, and the base chamber having an opening defined in a top thereof; the second end of the pipe of the pump is extended to the first opening of the highest box of the boxes.

9. The device as claimed in claim 8, wherein the external water supply is disposed on one side of the box adjacent to the lowest box of the case.
